(19) United States
(12) Patent Application Publication
(10) Pub. No.: US 2013/0167691 A1
(43) Pub. Date: Jul. 4, 2013

(54) DRYWALL SCREWDRIVER

(71) Applicants: Andre Ullrich, Leinfelden-Echterdingen (DE); Holger Ruebsaamen, Stuttgart (DE)

(72) Inventors: Andre Ullrich, Leinfelden-Echterdingen (DE); Holger Ruebsaamen, Stuttgart (DE)

(73) Assignee: Robert Bosch GmbH, Stuttgart (DE)

(21) Appl. No.: 13/536,462

(22) Filed: Jun. 28, 2012

(30) Foreign Application Priority Data
Jun. 30, 2011 (DE) 10 2011 078 380.6

(51) Int. Cl. B25B 23/00; B25B 23/18; B25B 21/00

(52) U.S. Cl. CPC B25B 23/0064; B25B 21/002; B25B 23/18
USPC 81/57.11; 173/46; 173/217

(57) ABSTRACT

A drywall screwdriver includes a housing, a screw-in depth limiting element, and a gearing unit. The drywall screwdriver further includes a coupling unit, an output spindle, an electric motor, and a battery receptacle region. The housing of the screwdriver has at least one hand grip region. An overall weight of the drywall screwdriver is less than 1.2 kg.

This application claims priority under 35 U.S.C. §119 to patent application no. DE 10 2011 078 380.6, filed on Jun. 30, 2011 in Germany, the disclosure of which is incorporated herein by reference in its entirety.

### BACKGROUND

The disclosure relates to a drywall screwdriver.

A drywall screwdriver, having a housing, having a screw-in depth limiting element, having a gearing unit, having a coupling unit, having an output spindle, having an electric motor and having a battery receptacle region, wherein the housing has at least one hand grip region, is already known.

### SUMMARY

The disclosure is based on a drywall screwdriver, having a housing, having a screw-in depth limiting element, having a gearing unit, having a coupling unit, having an output spindle, having an electric motor and having a battery receptacle region, wherein the housing has at least one hand grip region.

It is proposed that the drywall screwdriver has an overall weight of less than 1.2 kg. In this context, a “drywall screwdriver” is to be understood in particular to mean a hand-held power tool which is provided for working in particular on materials such as for example plasterboard and preferably for screwing screws into materials such as for example plasterboard. “Provided” is to be understood in particular to mean specially designed, configured and/or equipped. In this context, a “screw-in depth limiting element” is to be understood in particular to mean an element which is at least substantially provided for limiting a screw-in depth of the drywall screwdriver. In a particularly preferred exemplary embodiment, the screw-in depth limiting element has a depth stop. A screw-in depth of the screw-in depth limiting element can preferably be adjustable. Other limiting parameters which would appear expedient to a person skilled in the art, such as for example a rotational speed or a torque, are however also conceivable. The screw-in depth limiting element may be electronic, magnetic or optical or of some other form which would appear expedient to a person skilled in the art. In a particularly preferred exemplary embodiment, the screw-in depth limiting element is of mechanical form. In this context, an “overall weight” is to be understood in particular to mean the weight of the entire drywall screwdriver excluding accessories such as a magazine unit, a battery, in particular a drywall screwdriver battery, a tool insert. The electric motor may be formed as a direct-current motor (DC motor) or as a brushless direct-current motor (EC motor).

The overall weight of the drywall screwdriver is in particular less than 1.2 kg, preferably less than 1 kg and particularly preferably less than 0.8 kg. In a particularly preferred exemplary embodiment, the overall weight of the drywall screwdriver is at least substantially 0.7 kg. In this context, “at least substantially” is to be understood in particular to mean a deviation from the specified value in particular by less than 20%, preferably less than 10% and particularly preferably less than 5%.

The lightweight design of the drywall screwdriver according to the disclosure allows an operator to carry out work in an advantageously comfortable manner. Furthermore, the strain on an operator during a long period of use of the drywall screwdriver can advantageously be reduced. In particular in this field of occupation and/or activity, it is in particular the case that a multiplicity of screws are screwed into a material to be worked, such as in particular into plasterboard panels, in a short period of time. The low overall weight of the drywall screwdriver according to the disclosure can result in a preferably low strain on an operator.

Furthermore, advantageously simple and comfortable transport is possible as a result of the advantageously low overall weight of the drywall screwdriver. It can furthermore be achieved that an operator of the drywall screwdriver can carry the drywall screwdriver even during other working steps in which the drywall screwdriver remains unused, without the drywall screwdriver hindering the operator during the other working steps.

It is also proposed that the drywall screwdriver has a first overall length of less than 232.5 mm. In this context, a “first overall length” is to be understood in particular to mean the distance between a first plane and a second plane, wherein the first plane runs at least substantially perpendicular to an axis of the output spindle and a first extremity of the drywall screwdriver as viewed in the axial direction, said first extremity preferably being formed by the screw-in depth limiting element, lies in the first plane, and wherein the second plane runs parallel to the first plane and a second extremity of the drywall screwdriver as viewed in the axial direction, said second extremity preferably being formed by the housing of the drywall screwdriver, lies in the second plane. Here, the first overall length is measured when the screw-in depth limiting element is in a state in which the screw-in depth limiting element has a shortest, in particular adjustable, length in the axial direction. In this context, an “axial direction” is to be understood in particular to mean a direction which runs parallel to the axis of the output spindle.

In a particularly preferred exemplary embodiment, the first overall length of the drywall screwdriver lies at least substantially in a range between 200 mm and 230 mm. In this context, “at least substantially” is to be understood in particular to mean a deviation from the specified value in particular by less than 20%, preferably less than 10% and particularly preferably less than 5%.

In this way, it is possible to obtain a drywall screwdriver which is advantageously compact and of small construction and which can be used flexibly in particular at locations where there is extremely limited space. Furthermore, advantageously simple and comfortable transport is possible as a result of the advantageously small first overall length of the drywall screwdriver. It can furthermore be achieved that an operator of the drywall screwdriver can carry the drywall screwdriver even during other working steps in which the drywall screwdriver remains unused, without the drywall screwdriver hindering the operator during the other working steps. It can therefore be achieved that the drywall screwdriver is always to hand for the operator in an advantageously simple and comfortable manner.

It is also proposed that the drywall screwdriver has a first ergonomic overall length of less than 206 mm. In this context, a “first ergonomic overall length” is to be understood in particular to mean a distance, along the axis of the output spindle, between a first plane and a fifth plane, wherein the first plane runs at least substantially perpendicular to an axis of the output spindle and a first extremity of the drywall screwdriver as viewed in the axial direction, said first extremity preferably being formed by the screw-in depth limiting element, lies in the first plane, and wherein the fifth plane runs parallel to the first plane and wherein in particular an apex of a grip recess, which is concavely curved as viewed in the axial direction, of a hand grip region lies in the fifth plane. Here, the first ergonomic overall length is measured when the screw-in depth limiting element is in a state in which the screw-in depth limiting element has a shortest, in particular adjustable, length in the axial direction.

The first ergonomic overall length is in particular less than 206 mm, preferably less than 200 mm and particularly preferably less than 195 mm. In a particularly preferred exemplary embodiment, the first ergonomic overall length is at least substantially 192 mm.

In this way, it is possible to obtain a drywall screwdriver which is advantageously compact and of small construction and which can be used flexibly in particular at locations where there is extremely limited space. Furthermore, as a result of the advantageously small first ergonomic overall length of the drywall screwdriver, it is possible to obtain an advantageously good force flow and a preferably high level of working comfort for an operator.

It is also proposed that the drywall screwdriver has a second overall length of less than 230 mm. In this context, a “second overall length” is to be understood in particular to mean the distance between a third plane and a fourth plane, wherein the third and fourth planes are arranged perpendicular to a battery base surface and a third extremity of the drywall screwdriver as viewed in the axial direction, said third extremity preferably being formed by the screw-in depth limiting element, lies in the third plane, and a fourth extremity of the drywall screwdriver as viewed in the axial direction, said fourth extremity preferably being formed by the housing of the drywall screwdriver, lies in the fourth plane. In this context, a “battery base surface” is to be understood in particular to mean an at least substantially planar surface which is formed by at least a part of a second region of a drywall screwdriver battery inserted into the battery receptacle region and which, in an inserted state of the drywall screwdriver battery, is arranged facing away from the housing of the drywall screwdriver. Here, the second overall length is measured when the screw-in depth limiting element is in a state in which the screw-in depth limiting element has a shortest, in particular adjustable, length in the axial direction.

The second overall length of the drywall screwdriver is in particular less than 230 mm, preferably less than 220 mm and particularly preferably less than 210 mm. In a particularly preferred exemplary embodiment, the second overall length of the drywall screwdriver is at least substantially 205 mm. In this context, “at least substantially” is to be understood in particular to mean a deviation from the specified value in particular by less than 20%, preferably less than 10% and particularly preferably less than 5%.

In this way, it is possible to obtain a drywall screwdriver which is advantageously compact and of small construction and which can be used flexibly in particular at locations where there is extremely limited space. Furthermore, advantageously simple and comfortable transport is possible as a result of the advantageously small second overall length of the drywall screwdriver. It can furthermore be achieved that an operator of the drywall screwdriver can carry the drywall screwdriver even during other working steps in which the drywall screwdriver remains unused, without the drywall screwdriver hindering the operator during the other working steps. It can therefore be achieved that the drywall screwdriver is always to hand for the operator in an advantageously simple and comfortable manner.

It is also proposed that the drywall screwdriver has a second ergonomic overall length of less than 204 mm. In this context, a “second ergonomic overall length” is to be understood in particular to mean the distance between a third plane and a sixth plane, wherein the third and sixth planes are arranged perpendicular to the battery base surface and wherein a third extremity of the drywall screwdriver as viewed in the axial direction, said third extremity preferably being formed by the screw-in depth limiting element, lies in the third plane, and in particular an apex of a grip recess, which is concavely curved as viewed in the axial direction, of a hand grip region lies in the sixth plane. Here, the second ergonomic overall length is measured when the screw-in depth limiting element is in a state in which the screw-in depth limiting element has a shortest, in particular adjustable, length in the axial direction.

The second ergonomic overall length is in particular less than 200 mm and preferably less than 195 mm. In a particularly preferred exemplary embodiment, the second ergonomic overall length is at least substantially 192 mm.

In this way, it is possible to obtain a drywall screwdriver which is advantageously compact and of small construction and which can be used flexibly in particular at locations where there is extremely limited space. Furthermore, as a result of the advantageously small second ergonomic overall length of the drywall screwdriver, it is possible to obtain an advantageously good force flow and a preferably high level of working comfort for an operator.

It is also proposed that the battery receptacle region is arranged at least substantially entirely radially within the housing. In this context, “radially within” is to be understood in particular to mean that the battery receptacle region is arranged behind the housing of the drywall screwdriver as viewed in a radial direction from the outside inward. In this context, a “radial direction” is to be understood in particular to mean a direction which extends perpendicular to a main direction of extent of a partial region of the housing in which the battery receptacle region is arranged. In a particularly preferred exemplary embodiment, the battery receptacle region is provided to at least substantially completely receive a drywall screwdriver battery. In this context, “at least substantially” is to be understood in particular to mean that in particular at least 60%, preferably at least 75% and particularly preferably at least 90% of the drywall screwdriver battery is arranged radially within the battery receptacle region.

In this way, it is possible to obtain an embodiment of the drywall screwdriver which is advantageously compact and of small construction even with a drywall screwdriver battery inserted into the battery receptacle region and which can be used flexibly in particular at locations where there is extremely limited space. Furthermore, it is possible to obtain advantageously simple and comfortable transport of the drywall screwdriver with a drywall screwdriver battery inserted therein to a usage site or at a usage site of the drywall screwdriver.

It is also proposed that a diameter of the electric motor is less than 44 mm. In this context, a “diameter” of the electric motor is to be understood in particular to mean a dimension of the electric motor running perpendicular to a motor spindle. The diameter of the electric motor is preferably less than 42 mm and particularly preferably less than 40 mm. In a particularly preferred exemplary embodiment, the diameter of the electric motor is at least substantially 39 mm. In this context, “at least substantially” is to be understood in particular to mean a deviation from the specified value in particular by less than 20%, preferably less than 10% and particularly preferably less than 5%.

In this way, it is possible in an advantageously simple manner to obtain a compact design of the drywall screwdriver, in particular in a direction extending perpendicular to the axial direction.

It is also proposed that the gearing unit comprises at least one planetary gear set. The planetary gear set comprises preferably at least two, preferably three planet gears and also at least one sun gear or pinion. Furthermore, the planetary gear set preferably comprises a planet carrier which comprises at least two, preferably three journals provided for mounting the planet gears. Furthermore, the planetary gear set preferably has at least one internal gear.

In this way, it is possible in particular to obtain an embodiment of the drywall screwdriver which is advantageously of short construction and compact in the axial direction. Furthermore, through the use of a planetary gear set, it is possible to obtain a preferably robust and cheap embodiment of the gearing unit. Furthermore, it is possible to obtain an advantageously symmetrical design and an advantageously rectilinear transmission of forces and torques from the electric motor via the gearing unit to the output spindle.

It is also proposed that the planetary gear set is of single-stage design. It is thereby possible to obtain an embodiment of the drywall screwdriver which is advantageously of short construction and compact in the axial direction. Furthermore, it is possible in an advantageously simple manner to save on components, such that an advantageously low level of assembly outlay can be attained and assembly costs can be lowered.

It is also proposed that the gearing unit has a transmission ratio of between 3 and 10. In this context, a “transmission ratio” is to be understood in particular to mean the ratio of at least one input parameter and at least one output parameter of the gearing unit. In a particularly preferred exemplary embodiment, the transmission ratio of the gearing unit is to be understood to mean in particular the ratio between a rotational speed of the motor spindle of the electric motor and the rotational speed of the output spindle. The transmission ratio of the gearing unit is in particular between 3 and 10, preferably between 5 and 8 and particularly preferably between 3.3 and 8. In a particularly preferred exemplary embodiment, the transmission ratio of the gearing unit is at least substantially 7.67. In this context, “at least substantially” is to be understood in particular to mean a deviation from the specified value in particular by less than 20%, preferably less than 10% and particularly preferably less than 5%.

By means of the design of the gearing unit according to the disclosure, an advantageously high rotational speed of the output spindle of the drywall screwdriver can be attained, as a result of which an advantageously high working efficiency of the drywall screwdriver can be attained.

It is also proposed that the gearing unit and the electric motor are provided to generate a maximum rotational speed of the output spindle of between 2000 rpm and 7000 rpm. The rotational speed may be in particular between 2500 rpm and 6000 rpm and preferably between 2700 rpm and 5000 rpm. In this context, said values are intended to apply in particular to an unloaded state of the drywall screwdriver.

In this way, it is possible for a working step to be carried out advantageously quickly and to obtain high efficiency and a preferably high quality of work.

It is also proposed that the drywall screwdriver has an illumination unit which is at least substantially provided for illuminating a working area. In this way, an operator of the drywall screwdriver can advantageously clearly see the working area, such that an advantageously precise working result can be achieved.

Also proposed is a drywall screwdriver battery which is provided for being inserted into a battery receptacle region of the drywall screwdriver.

It is proposed that the drywall screwdriver battery has a nominal voltage of at least substantially at most 12V. In this context, a “nominal voltage” is to be understood in particular to mean a maximum voltage which the drywall screwdriver battery can provide in a fully charged state. In a particularly preferred exemplary embodiment, the nominal voltage of the drywall screwdriver battery is at least substantially at most 10.8 V. In a particularly preferred exemplary embodiment, the drywall screwdriver battery has three interconnected battery cells, in particular lithium-ion battery cells, which have in each case a nominal voltage of at least substantially at most 3.6 V. In a particularly preferred exemplary embodiment, the three battery cells of the drywall screwdriver battery may furthermore be provided so as to have in each case a charging end voltage of at least substantially 4.2 V.

In this way, it is possible to attain an embodiment of the drywall screwdriver battery which is advantageously of small construction, compact and lightweight.

It is also proposed that the drywall screwdriver battery has an overall weight of less than 0.375 kg. The overall weight of the drywall screwdriver battery may in particular be less than 0.3 kg, preferably less than 0.2 kg and particularly preferably at least substantially 0.171 kg. This permits advantageously simple and comfortable handling of the drywall screwdriver with a drywall screwdriver battery according to the disclosure inserted therein.

Also proposed is a system which comprises a drywall screwdriver and a drywall screwdriver battery, wherein the drywall screwdriver battery has an outer surface which, in an inserted state in the battery receptacle region of the drywall screwdriver, at least partially adjoins at least one grip region of the drywall screwdriver. Here, the outer surface serves preferably as a part of the grip region which is gripped by the user of the drywall screwdriver in a state of use. In this way, it is possible in particular to obtain a preferably compact embodiment of the drywall screwdriver, wherein furthermore an advantageously high level of user operating comfort can be attained.

### BRIEF DESCRIPTION OF THE DRAWINGS

Further advantages will emerge from the following description of the drawing. The drawing illustrates an exemplary embodiment of the disclosure. The drawing, the description and the claims contain numerous features in combination. A person skilled in the art will expediently also consider the features individually and combine them to form further meaningful combinations.

In the drawings:

FIG. 1 shows a side view of a drywall screwdriver according to the disclosure with a tool insert inserted therein and with a drywall screwdriver battery inserted therein, and

FIG. 2 shows a schematic sectional illustration of the drywall screwdriver according to the disclosure with the tool insert inserted therein and with the drywall screwdriver battery inserted therein,

FIG. 3a shows a schematic sectional illustration of the drywall screwdriver according to the disclosure,

FIG. 3b shows a side view of the drywall screwdriver battery according to the disclosure, and

FIG. 4 shows a schematic sectional illustration of the drywall screwdriver according to the disclosure with the tool insert inserted therein and with the drywall screwdriver battery inserted therein, during a screwing-in process.

### DETAILED DESCRIPTION

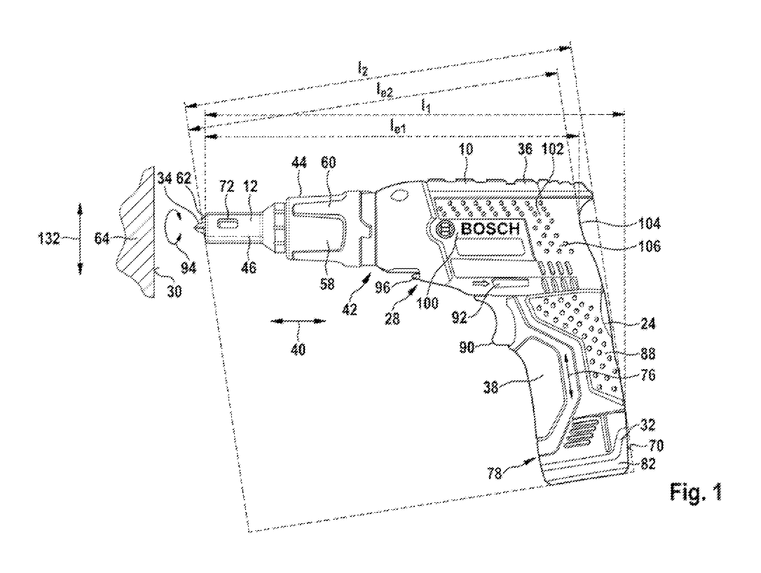

FIG. 1 illustrates a drywall screwdriver according to the disclosure with a tool insert 34 inserted therein and with a drywall screwdriver battery 32 inserted therein. The drywall screwdriver has a housing 10. The housing 10 comprises a first partial region 36 and a second partial region 38. The first and second partial regions 36, 38 of the housing 10 are arranged at least substantially perpendicular to one another. The drywall screwdriver furthermore has a gearing unit 14, a coupling unit 16, an output spindle 18 and an electric motor 20. The electric motor 20 has a diameter d of less than 44 mm. The diameter d of the electric motor 20 is 38.5 mm. The electric motor 20 is in the form of a direct-current motor.

The drywall screwdriver has an overall weight m of less than 1.2 kg. The overall weight m of the drywall screwdriver is at least substantially 0.7 kg. The overall weight m of the drywall screwdriver includes neither an overall weight m_{A} of the drywall screwdriver battery 32, which can be inserted into a battery receptacle region 22 of the drywall screwdriver, nor a weight of a tool insert 34.

The drywall screwdriver has a first overall length l₁ of less than 232.5 mm. The first overall length l₁ of the drywall screwdriver is at least substantially between 200 mm and 230 mm.

Furthermore, the drywall screwdriver has a second overall length l₂ of less than 230 mm. The second overall length l₂ of the drywall screwdriver is at least substantially 205 mm.

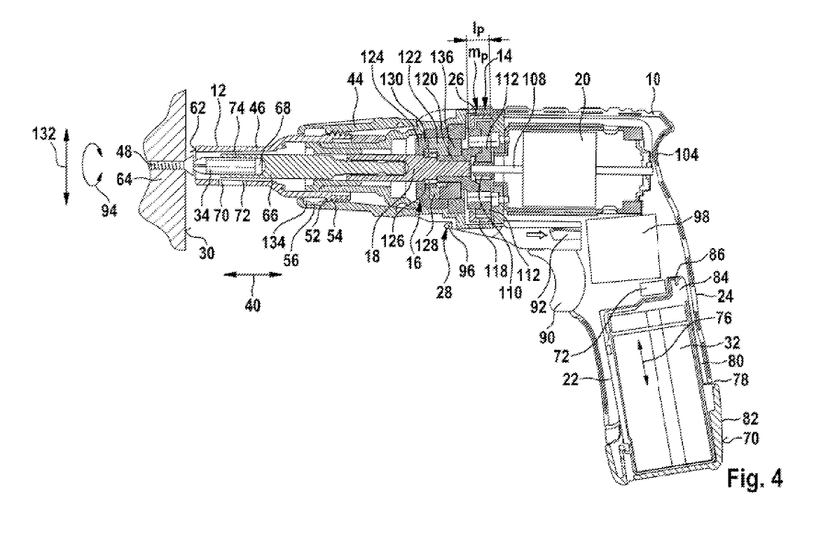

A screw-in depth limiting element 12 is arranged on an end 42 of the first partial region 36 facing away from the second partial region 38 as viewed in an axial direction 40 of the first partial region 36. The screw-in depth limiting element 12 is detachably connected to the housing 10 of the drywall screwdriver by means of a plug-in connection. The screw-in depth limiting element 12 comprises an adjusting sleeve 44. The screw-in depth limiting element 12 also comprises a depth stop 46. The depth stop 46 is provided for limiting a screw-in depth of a screw 48, illustrated in FIG. 4, during a screwing-in process. The adjusting sleeve 44 is provided for adjusting the screw-in depth. Here, the screw-in depth is set manually by means of the adjusting sleeve 44. For this purpose, an operator rotates the adjusting sleeve 44 about an axis which corresponds to an axis 50 of the output spindle 18. When the operator rotates the adjusting sleeve 44, the depth stop 46 is moved along the axial direction 40.

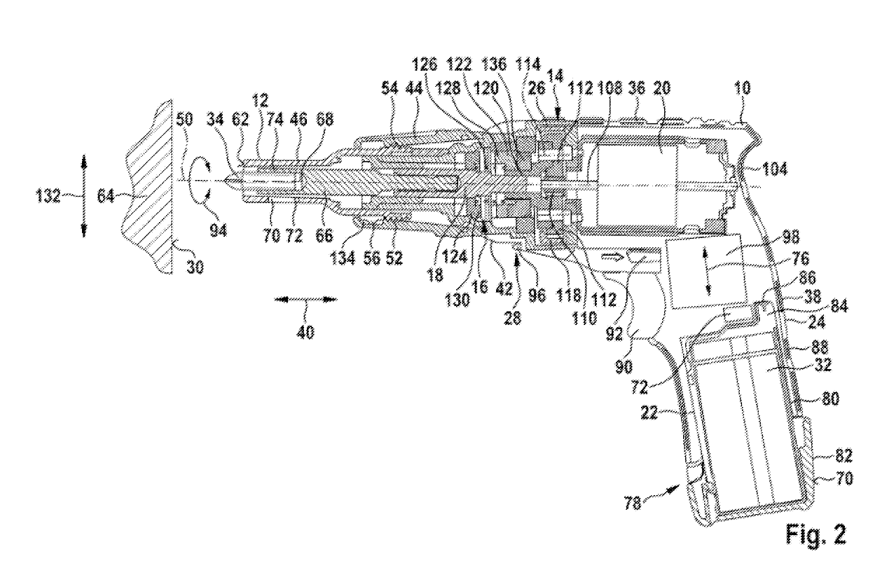

The adjusting sleeve 44 has an internal thread 52 (FIG. 2). The internal thread 52 extends over a partial region of an inner surface of the adjusting sleeve 44. The depth stop 46 has an external thread 54. The external thread 54 extends over a partial region of an outer surface of the depth stop 46. The external thread 54 of the depth stop 46 and the internal thread 52 of the adjusting sleeve 44 engage into one another when the screw-in depth limiting element 12 is in a mounted state. A spring element 56 is arranged in front of the depth stop 46 as viewed in the radial direction 132 from the outside inward. The spring element 56 pushes the depth stop 46 inward in the radial direction 132. The spring element 56 is arranged in a radially internal depression 134 of the adjusting sleeve 44. The radially internal depression 134 is arranged on an end of the adjusting sleeve 44 facing toward the depth stop 46 in the axial direction 40. The radially internal depression 134 secures the spring element 56 in the axial direction 40. The spring element 56 pushes flanks of the external thread 54 of the depth stop 46 in the radial direction 132 against flanks of the internal thread 52 of the adjusting sleeve 44 in a region situated opposite the spring element 56 in the radial direction 132. Friction is thus generated between the flanks of the internal thread 52 and of the external thread 54. An autonomous adjustment of the depth stop 46 can be reliably prevented by said friction. The screw-in depth limiting element 12 also has detent elements (not illustrated) which are provided for dividing the rotation of the adjusting sleeve 44 into individual detent steps. An autonomous adjustment of the depth stop 46 can also be reliably prevented by the detent elements.

The adjusting sleeve 44 has a grip region 58 arranged on an outer side of the adjusting sleeve 44. The grip region 58 has lamellar elevations 60. The grip region 58 is provided for increasing the ease with which the outer side of the adjusting sleeve 44 can be gripped, and thereby making it easier for the operator to rotate the adjusting sleeve 44.

The depth stop 46 has a stop surface 62 which, when the screw-in depth of the screw 48 (FIG. 4) as set by the operator is reached, bears against a surface of a workpiece 64 on which work is being carried out. The stop surface 62 has an annular cross section.

The drywall screwdriver has a tool receptacle 66. The tool receptacle 66 is formed by a bit holder. The tool insert 34 is formed by a screwdriver bit. The tool insert 34 is inserted into the tool receptacle 66. The tool insert 34 is captively held in the tool receptacle 66. For this purpose, the tool receptacle 66 has a magnet element 68 (FIG. 2). The tool insert 34, when inserted in the tool receptacle 66, extends in the axial direction 40 beyond the stop surface 62 as viewed from the adjusting sleeve 44 toward the depth stop 46. The tool insert 34 is driven in rotation by the output spindle 18 during the screwing-in process.

The bit holder which forms the tool receptacle 66 has an overall length l_{B} of between 45 mm and 75.5 mm. The tool receptacle 66 has a receptacle region 74. The receptacle region 74 is provided for receiving the tool insert 34. The receptacle region 74 has a hexagon socket contour (not illustrated in any more detail). The tool insert 34 has an external hexagon contour (not illustrated in any more detail). The hexagon socket contour of the receptacle region 74 corresponds to an external hexagon contour of the tool insert 34. The tool insert 34, in an inserted state, is held in a rotationally conjoint manner in the receptacle region 74 of the tool receptacle 66.

Arranged radially within the second partial region 38 of the housing 10 is the battery receptacle region 22. The battery receptacle region 22 is arranged entirely radially within the housing 10 of the drywall screwdriver. The drywall screwdriver battery 32 is detachably fastened in the battery receptacle region 22. The drywall screwdriver battery 32 is pushed into the battery receptacle region 22 parallel to a main direction of extent 76 of the second partial region 38 of the housing 10 as viewed from a free end 78 of the second partial region 38 toward the first partial region 36.

The drywall screwdriver battery 32 is designed as a lithium-ion battery. The drywall screwdriver battery 32 is formed by a drywall screwdriver battery. The drywall screwdriver battery 32 is provided for being inserted into the battery receptacle region 22 of the drywall screwdriver. The drywall screwdriver battery 32 has a nominal voltage in a fully charged state of 10.8 V. Deviations in the nominal voltage may arise as a result of material-induced inaccuracies. In such a case, the nominal voltage of the drywall screwdriver battery 32 is at most 12 V. The drywall screwdriver battery 32 has an overall weight m_{A} of less than 0.375 kg. The drywall screwdriver battery 32 has an overall weight m_{A} of 0.171 kg.

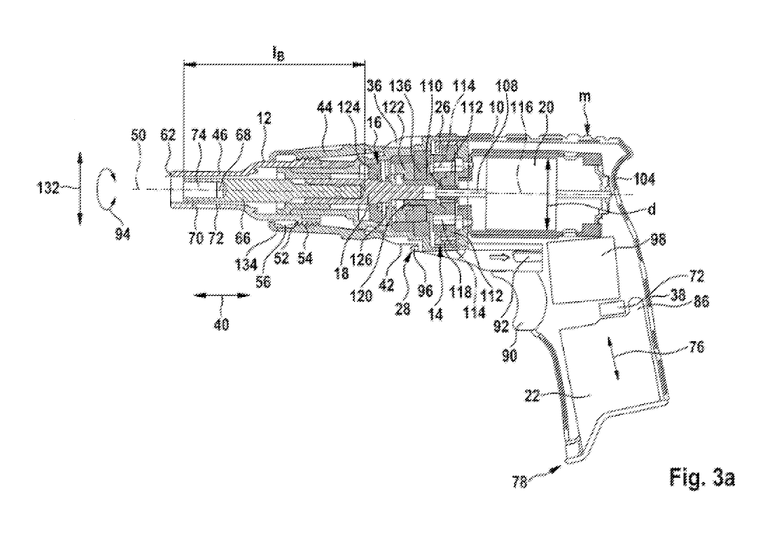

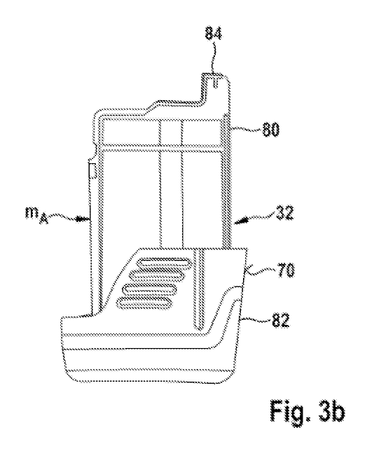

The drywall screwdriver battery 32 has a first region 80 and a second region 82 (FIG. 3b). The first region 80 of the drywall screwdriver battery 32 has a contact element 84. When the drywall screwdriver battery 32 is in an installed state in the battery receptacle region 22 of the drywall screwdriver, the contact element 84 is in electrical contact with a contact element 86 of the battery receptacle region 22 of the drywall screwdriver. The contact elements 84, 86 of the drywall screwdriver battery 32 and of the battery receptacle region 22 are provided for supplying electrical energy of the drywall screwdriver battery 32 to the drywall screwdriver.

When the drywall screwdriver battery 32 is in an installed state, a surface of the first region 80 of the drywall screwdriver battery 32 bears against the battery receptacle region 22 of the drywall screwdriver. In an inserted state in the drywall screwdriver, an outer surface 70 of the second region 82 of the drywall screwdriver battery 32 forms an extension of the housing 10 of the drywall screwdriver. When the drywall screwdriver battery 32 is in an installed state, the second region 82 of the drywall screwdriver battery 32 adjoins, in the main direction of extent 76, the free end 78 of the second partial region 38 of the housing 10, and thus forms a part of a hand grip region 102.

As viewed in the axial direction 40, a first hand grip region 24 is arranged on an outer side, which faces away from the screw-in depth limiting element 12, of the second partial region 38 of the housing 10. The first hand grip region 24 comprises a grip element 88. The grip element 88 is formed in part by an elastomer. An actuating element 90 is arranged on an outer side, which faces toward the screw-in depth limiting element 12 as viewed in the axial direction 40, of the second partial region 38 of the housing 10. The actuating element 90 is provided for actuating the electric motor 20 arranged within the housing 10. The actuating element 90 is formed by an actuating button.

The first partial region 36 of the housing 10 has a switching element 92. The switching element 92 is provided for switching between two directions of rotation 94 of the electric motor 20 in an operational state. The switching element 92 is arranged on a side, which faces toward the second partial region 38 as viewed in the main direction of extent 76 of the second partial region 38, of the first partial region 36 of the housing 10. Furthermore, the switching element 92 is arranged at least substantially in the center of the first partial region 36 of the housing 10 as viewed in the axial direction 40. The switching element 92 is arranged at the level of the actuating element 90 as viewed in the axial direction 40. To switch the direction of rotation 94 of the electric motor 20, the operator switches the switching element 92 in a direction running perpendicular to the axial direction 40 and perpendicular to the main direction of extent 76 of the second partial region 38 of the housing 10.

The drywall screwdriver has an illumination unit 28. The illumination unit 28 comprises an illumination means 96. The illumination means 96 is formed by an LED. The illumination means 96 is arranged in the first partial region 36 of the housing 10. The illumination means 96 is arranged in front of the switching element 92 as viewed in the axial direction 40 from the second partial region 38 toward the screw-in depth limiting element 12. The illumination unit 28 comprises cabling (not illustrated). The cabling is connected to an electronic unit 72. The electronic unit 72 is formed by a printed circuit board. In an operational state of the drywall screwdriver, the cabling conducts electrical energy of the drywall screwdriver battery 32 to the illumination means 96. The illumination means 96 thus emits light in an operational state. When the drywall screwdriver is not in an operational state, the illumination means 96 is not supplied with electrical energy and does not emit light. The illumination means 96 is provided for illuminating a working area 30 of the drywall screwdriver in an operational state.

On an outer side of the first partial region 36 of the housing 10 there is provided an information area 100. The information area 100 has a manufacturer logo and a product designation of the drywall screwdriver.

The second hand grip region 102 is provided on an end of the first partial region 36 of the housing 10 facing away from the screw-in depth limiting element 12 as viewed in the axial direction 40. The second hand grip region 102 has a grip recess 104. The grip recess 104 extends in the axial direction 40 toward the screw-in depth limiting element 12. The second hand grip region 102 extends in a U shape around that end of the first partial region 36 of the housing 10 which faces away from the screw-in depth limiting element 12. The second hand grip region 102 has a grip element 106. The grip element 106 extends along the entire second hand grip region 102. The grip element 106 is formed by an elastomer. If the operator of the drywall screwdriver grips the drywall screwdriver by the second hand grip region 102, the force flow imparted by the operator during a screwing-in process is transmitted rectilinearly along the axis 50 of the output spindle 18 to the tool insert 34.

A distance between a first plane, in which the stop surface 62 of the depth stop 46 of the screw-in depth limiting element 12 is situated, and a fifth plane, in which a point of the grip recess 104 of the second hand grip region 102 which lies closest to the stop surface 46 as viewed in the axial direction 40 is situated, is at least substantially less than 206 mm. The distance forms a first ergonomic overall length lₑ₁ of the drywall screwdriver. The first ergonomic overall length lₑ₁ of the drywall screwdriver is at least substantially 192 mm.

The drywall screwdriver has a second ergonomic overall length lₑ₂ which is at least substantially less than 206 mm. The second ergonomic overall length lₑ₂ of the drywall screwdriver is at least substantially 192 mm.

FIG. 2 shows the drywall screwdriver in a sectional illustration. The battery receptacle region 22 is arranged in the second partial region 38 of the housing 10 of the drywall screwdriver. The drywall screwdriver battery 32 is inserted into and captively held in the battery receptacle region 22. For this purpose, the battery receptacle region 22 has a securing element (not illustrated in any more detail). The securing element is formed by a detent element. Other embodiments of the securing element which would appear expedient to a person skilled in the art are however also conceivable. The drywall screwdriver battery 32 has a securing element (not illustrated). The securing element of the drywall screwdriver battery 32 corresponds with the securing element of the battery receptacle region 22. The securing element of the drywall screwdriver battery 32 is formed by a detent element.

The electrical energy of the drywall screwdriver battery 32 is conducted in a manner not illustrated in any more detail to the electric motor 20 via the electronic unit 72 and via a switching unit 98. The actuating element 90 closes an electrical circuit in the switching unit 98 and in the electronic unit 72, whereby the electric motor 20 is placed into an operational state and converts the electrical energy of the drywall screwdriver battery 32 into kinetic energy.

By means of the switching element 92, an operator can influence the direction of rotation 94 of the electric motor 20, in that the switching element 92 transmits to the switching unit 98 a signal which triggers a change in the direction of rotation 94 of the electric motor 20. The kinetic energy of the electric motor 20 is transmitted to the output spindle 18 during a screwing-in process via the gearing unit 14 and the coupling unit 16. The gearing unit 14 has a transmission ratio of between 3 and 10. The transmission ratio of the gearing unit 14 is 7.67. The gearing unit 14 and the electric motor 20 are provided for generating a maximum rotational speed of the output spindle 18 of between 2000 rpm and 7000 rpm. The gearing unit 14 comprises a planetary gear set 26. The planetary gear set 26 of the gearing unit 14 is of single-stage design. The planetary gear set 26 has an overall weight mₚ of at least substantially 0.105 kg. The planetary gear set 26 has an overall length lₚ in the axial direction 40 of 22.6 mm.

The output spindle 18 is connected in a rotationally conjoint manner to the tool receptacle 66. The tool receptacle 66 is connected in a rotationally conjoint manner to the tool insert 34 inserted therein, and transmits the kinetic energy to the tool insert 34 (FIG. 4).

The electric motor 20 comprises a motor spindle 108. In an operational state, the electric motor 20 generates a rotational movement of the motor spindle 108. A gearwheel is arranged on the motor spindle 108. The gearwheel forms a sun gear 110 of the planetary gear set 26 of the gearing unit 14. In an operational state, the sun gear 110 of the planetary gear set 26 meshes with planet gears 112 of the planetary gear set 26. In an operational state, the planet gears 112 in each case rotate about an axis of rotation 114 of the planet gears 112. Furthermore, the planet gears 112 rotate about an axis of rotation 116 of the sun gear 110. The axis of rotation 116 of the sun gear 110 corresponds to an axis of rotation of the motor spindle 108. The axis of rotation 116 of the sun gear 110 corresponds to the axis 50 of the output spindle 18. In an operational state, the planet gears 112 mesh with an internal gear 118 of the planetary gear set 26. The internal gear 118 of the planetary gear set 26 is arranged in the housing 10 of the drywall screwdriver in a rotationally conjoint manner relative to the housing 10 of the drywall screwdriver. The planet gears 112 comprise in each case one connecting element 120. The connecting element 120 is formed by a planet carrier. The connecting element 120 is provided for transmitting the rotational movement of the planet gears 112 about the axis of rotation 116 of the sun gear 110 to the coupling unit 16.

The coupling unit 16 is in the form of a claw coupling (FIG. 2). The coupling unit 16 has a first coupling element 122, a second coupling element 124 and a third coupling element 136. The first coupling element 122 is connected via the connecting element 120 and the third coupling element 136 to the planet gears 112 of the planetary gear set 26. The connecting element 120 is fixedly connected to the third coupling element 136 of the coupling unit 14. In an operational state, the first coupling element 122 is driven in rotation by the gearing unit 14. The second coupling element 124 is connected to the output spindle 18. A spring element 126 is arranged between the first and second coupling elements 122, 124 as viewed in the axial direction 40. The spring element 126 is in the form of a helical spring. The spring element 126 is provided for placing the first and second coupling elements 122, 124 out of engagement in a non-actuated state. For this purpose, the spring element 126 pushes the first and second coupling elements 122, 124 apart in the axial direction 40.

FIG. 4 shows the drywall screwdriver in a state in which it is actuated by an operator. Here, the operator presses the drywall screwdriver in the axial direction 40, as viewed from the second hand grip region 102 toward the screw-in depth limiting element 12, against a head of the screw 48. The screw 48 is supported in the axial direction 40 on the workpiece 64 on which work is to be carried out. The force exerted on the drywall screwdriver by a user during a screwing-in process causes the second coupling element 124 to move toward the first coupling element 122 counter to a spring force of the spring element 126. The first and second coupling elements 122, 124 each have driving elements 128, 130. The driving elements 128, 130 project in each case in the axial direction out of the first or the second coupling element 122, 124 respectively. The driving elements 128, 130 are provided so as to bear against one another in a circumferential direction of the rotational movement of the gearing unit 14 in an actuated state. In so doing, the coupling elements 128 of the first coupling element 122 transmit the rotational movement of the gearing unit 14 to the driving elements 130 of the second coupling element 124 and thus to the second coupling element 124.

When the screw-in depth of the screw 48 as set by the operator is reached, the stop surface 62 of the depth stop 46 bears against a surface of the workpiece 64. In this state, the force exerted on the drywall screwdriver in the axial direction by the operator is transmitted via the depth stop 46 to the workpiece 64 rather than to the tool insert 34. As a result, the second coupling element 124, which is subjected to load by the spring element 126, passes out of engagement with the first coupling element 122, such that the rotational movement is no longer transmitted to the second coupling element 124 or to the tool insert 34.

What is claimed is:

1. A drywall screwdriver, comprising:
a housing;
a screw-in depth limiting element;
a gearing unit;
a coupling unit;
an output spindle;
an electric motor; and
a battery receptacle region;
wherein the housing has at least one hand grip region, and
wherein the drywall screwdriver has an overall weight of less than 1.2 kg.

2. The drywall screwdriver according to claim 1, wherein the drywall screwdriver has a first overall length of less than 232.5 mm.

3. The drywall screwdriver according to claim 1, wherein the drywall screwdriver has a first ergonomic overall length of less than 206 mm.

4. The drywall screwdriver according to claim 2, wherein the drywall screwdriver has a second overall length of less than 230 mm.

5. The drywall screwdriver according to claim 3, wherein the drywall screwdriver has a second ergonomic overall length of less than 204 mm.

6. The drywall screwdriver according to claim 1, wherein the battery receptacle region is arranged at least substantially entirely radially within the housing.

7. The drywall screwdriver according to claim 1, wherein the electric motor has a diameter of less than 44 mm.

8. The drywall screwdriver according to claim 1, wherein the gearing unit includes at least one planetary gear set.

9. The drywall screwdriver according to claim 8, wherein the planetary gear set is of single-stage design.

10. The drywall screwdriver according to claim 1, wherein the gearing unit has a transmission ratio of between 3 and 10.

11. The drywall screwdriver according to claim 1, wherein the gearing unit and the electric motor are configured to generate a rotational speed of the output spindle of between 2000 rpm and 7000 rpm.

12. The drywall screwdriver according to claim 1, further comprising an illumination unit that is at least substantially configured to illuminate a working area.

13. A drywall screwdriver battery having a nominal voltage of at least substantially at most 12V, the drywall screwdriver battery being configured to be inserted into a battery receptacle region of a drywall screwdriver, the drywall screwdriver including:
a housing;
a screw-in depth limiting element;
a gearing unit;
a coupling unit;
an output spindle; and
an electric motor;
wherein the housing has at least one hand grip region, and
wherein the drywall screwdriver has an overall weight of less than 1.2 kg.

14. The drywall screwdriver battery according to claim 13, wherein the drywall screwdriver battery has an overall weight of less than 0.375 kg.

15. A system, comprising:
a drywall screwdriver including:
a housing;
a screw-in depth limiting element;
a gearing unit;
a coupling unit;
an output spindle;
an electric motor; and
a battery receptacle region;
wherein the housing has at least one hand grip region, and
wherein the drywall screwdriver has an overall weight of less than 1.2 kg; and
at least one drywall screwdriver battery configured to be inserted into the battery receptacle region of the drywall screwdriver, the at least one drywall screwdriver battery having one or more of a nominal voltage of at least substantially at most 12V and an overall weight of less than 0.375 kg.

16. The system according to claim 15, wherein the drywall screwdriver battery has an outer surface that at least partially adjoins at least one grip region of the drywall screwdriver when the drywall screwdriver battery is in an inserted state in the battery receptacle region of the drywall screwdriver.
